(19) United States
(12) Patent Application Publication
(10) Pub. No.: US 2009/0164321 A1
(43) Pub. Date: Jun. 25, 2009

(54) METHOD AND SYSTEM FOR AWARDING USER POINTS IN RESPONSE TO USER INTEREST

(76) Inventor: John Andrew Vasilakos, Vancounver (CA)

Correspondence Address: Ruttler Law PLLC;One Union Square, 600 University Street, Suite 1919, Seattle, WA, 98101, US

(21) Appl. No.: 12/338,635

(22) Filed: Dec. 18, 2008

Related U.S. Application Data
(60) Provisional application No. 61/016,456, filed on Dec. 22, 2007.

(51) Int. Cl. G06Q 30/00; G06Q 10/00; G06Q 90/00

(52) U.S. Cl. 705/14; 705/26; 705/1

(57) ABSTRACT

A method and system for awarding user points in response to user interest is provided. User points are redeemable for price discounts on products and services. The method involves, in response to receiving a user request for information, presenting to the user a question, receiving a user response from the user and incrementing a points balance associated with the user in response to the user response. The system includes a server for communicating with a user; a database for storing a points balance associated with the user; a question-and-answer component operable to present a question to the user and receive a user response from the user; and a points balance component operable to increment the points balance in response to the user response. The method and system are applicable to a theme-based website in which the questions presented to the user relate to the website theme.

### PRIORITY CLAIM

This application claims the benefit of U.S. provisional patent application Ser. No. 61/016,456 filed Dec. 22, 2007 (our ref. F2YI-1-1001). The foregoing application is incorporated by reference in its entirety as if fully set forth herein.

### FIELD OF THE INVENTION

This invention relates to information technology and, in particular, to a method and system for awarding user points in response to user interest.

### BACKGROUND

Websites, including web portals, can transmit information over an Internet connection for display at a user computer in response to a user request for such information, which can be delivered in the form of text, graphics, hypertext links and other information presented in web pages and other documents or in the form of multimedia files such as audio files and video files. However, merely delivering requested information to a user does not reward the user in response to that user's interest in a business, product or service.

Several organizations have awarded points to their customers for purchasing goods and services offered by that organization. Credit card companies have awarded points to their customers for using their credit card to purchase goods and services from other organizations. Customers have redeemed their points to obtain products or services for free or at discounted prices. The products or services can be supplied by the organization that awarded the points or by other participating organizations. However, such points schemes do not, or are limited in their ability to, reward customers in response to the users demonstrating their interest in a business, product or service.

### SUMMARY

The above shortcomings may be addressed by providing, in accordance with one aspect of the invention, a method for awarding user points in response to user interest. The method involves incrementing a points balance associated with the user by a specified number of points in response to user interest. The method may involve incrementing a points balance associated with the user by a specified number of points in response to the user demonstrating user interest. The points balance may be incremented in response to the user interacting with a website. The points balance may be incremented in response to receiving a user selection of a Hyperlink, receiving a user response to a question, receiving information submitted by the user or any combination thereof. Receiving a user selection of a Hyperlink may involve receiving a user selection of a Hyperlink to a Web page providing information about a business, product or service. Receiving a user selection of a Hyperlink may involve receiving a user selection indicating a user response to a question. Receiving information submitted by a user may involve receiving a user response to a question. Receiving a user response to a question may involve receiving from the user an answer to a question presented to the user. Receiving a user response to a question may involve receiving from the user a correct answer. Receiving from the user a correct answer may involve receiving from the user one correct answer to a multiple-choice type question. Receiving from the user a correct answer may involve receiving one correct answer from among a plurality of correct answers. Receiving from the user a correct answer may involve receiving one correct answer among a plurality of answers, some of which are incorrect and at least one of which is correct.

The method may further involve presenting a question to the user. Presenting a question to the user may involve presenting the question in response to the user interacting with a website. Presenting the question in response to the user interacting with a website may involve presenting the question in response to receiving a user request for information. Presenting the question may involve presenting the question in response to receiving a user selection of a Hyperlink Presenting the question may involve presenting the question in response to receiving a user selection of a Hyperlink indicative of a user request for information. Presenting the question may involve presenting to the user a question associated with a specified level of question. Presenting the question may involve presenting to the user a question associated with a specified level of difficulty, presenting to the user a question associated with a specified category, such as a question topic, or any combination thereof. Presenting the question may involve presenting a question selected in response to a user profile, a user history, a predetermined or selected points earning method, or any combination thereof.

The method may further involve receiving a user request for information. Receiving a user request for information may involve receiving a user selection of a Hyperlink

The method may further involve presenting to the user information requested by the user. Presenting to the user information requested by the user may involve presenting user requested information about a stakeholder. Presenting to the user information requested by the user may involve linking to a web page displaying the user requested information. Linking to a web page displaying user requested information may involve linking to an internal web page, linking to an external web page, or any combination thereof.

The method may further involve receiving a user request for a question. Receiving a user request for a question may involve receiving a user request for a question having at least one answer to which, if selected by the user, will result in that user's points balance being incremented.

The method may further involve decrementing a points balance associated with the user by a number of redeemed points. Decrementing a points balance may involve decrementing the points balance in response to delivering media content to the user. Delivering media content to the user may involve receiving a request for the media content. Decrementing a points balance may involve decrementing the points balance in response to a purchase by the user from a participating organization.

In accordance with another aspect of the invention, there is provided a system for awarding user points in response to user interest. The system includes a database for storing a points balance of a user; and a points balance component operable to increment the points balance. The points balance component may be operable to decrement the points balance. The system may include a question and answer component operable to present a question to the user. The question and answer component may be operable to receive from the user an answer to a presented question. The system may include an information presentation component operable to present to the user information requested by that user. The database may be operable to store a user profile and user account information. The database may be operable to store a stakeholder profile containing information related to that stakeholder.

Other aspects and features of the present invention will become apparent to those of ordinary skill in the art upon review of the following description of embodiments of the invention in conjunction with the accompanying figures and claims.

### BRIEF DESCRIPTION OF THE DRAWINGS

Embodiments of the present invention are described in detail below with reference to the following drawings:

FIG. 1 is a block diagram of a system for awarding user points in response to user interest, in accordance with an embodiment of the invention;

FIG. 2 is a flow diagram of a method of the system shown in FIG. 1, showing steps for awarding user points in response to user interest, in accordance with an embodiment of the invention;

FIG. 3 is a dialog box presented to the user of the system shown in FIG. 1, showing a question section, an answer section and a response section, in accordance with an embodiment of the invention;

FIG. 4 is a method of the system shown in FIG. 1, showing steps for adjusting a points balance, in accordance with an embodiment of the invention;

FIG. 5 is a representation of a Player web page produced by the system shown in FIG. 1 for display at a user access device, showing a Video Mode button, a Plus Mode Hyperlink button and a Launch Plus Hyperlink button, in accordance with an embodiment of the invention;

FIG. 6 is a representation of the Player web page shown in FIG. 5, showing the Player web page presented in a video mode, in accordance with an embodiment of the invention; and

FIG. 7 is a representation of a Plus web page produced by the system shown in FIG. 1 for display at a user access device, showing a list of Teams and a list of Sponsors, in accordance with an embodiment of the invention.

### DETAILED DESCRIPTION

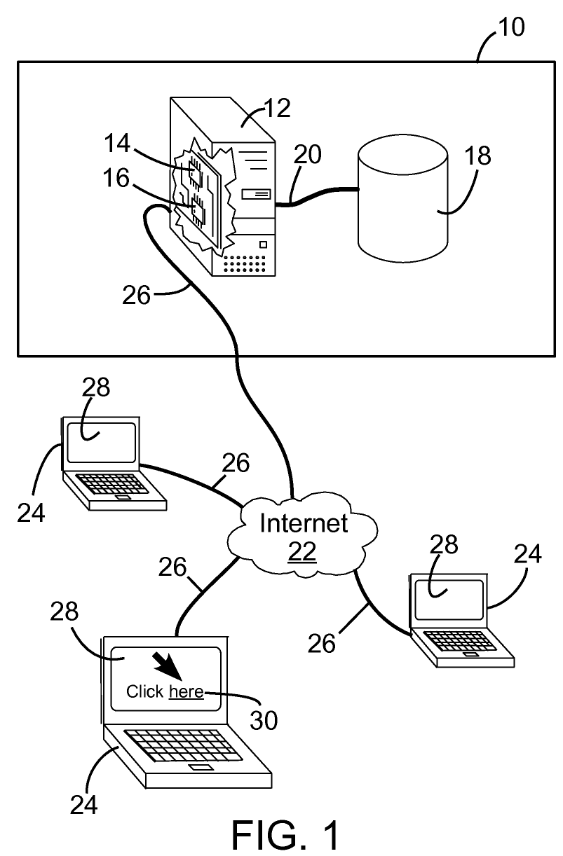

This invention relates to information technology and, in particular, to a method and system for awarding user points in response to user interest. Specific details of certain embodiments of the invention are set forth in the following description and in FIGS. 1-7 to provide a thorough understanding of such embodiments. The present invention may have additional embodiments, may be practiced without one or more of the details described for any particular described embodiment, or may have any detail described for one particular embodiment practiced with any other detail described for another embodiment.

A system for awarding user points in response to user interest includes: server means for communicating with a user; database means for storing a points balance associated with the user; question-and-answer means for presenting a question to the user and receiving a user response from the user; and points balance means for incrementing the points balance in response to the user response.

Referring to FIG. 1, the system according to a first and preferred embodiment of the invention is shown generally at 10. The system 10 functions to award user points in response to user interest. A user can demonstrate user interest by selecting a Hyperlink, answering a question appearing in a dialog box or pop-up, submitting information or any combination thereof, for example. The questions may be selected to educate the user about a particular business or its products, for example. Accumulated user points can be redeemed by the user to obtain price discounts on products or services, for example.

The system 10 includes a server 12 having a processing circuit, such as the processor 14 shown in FIG. 1, and a memory circuit 16. The system also includes a database 18, which is shown in FIG. 1 connected to the server 12 by a database connection 20.

The server 12 may be any computing device such as a general purpose computer, microcomputer, minicomputer, mainframe computer, distributed network for computing, functionally equivalent discrete hardware components, etc. and any combination thereof, for example.

The processor 14 is typically a processing circuit that includes one or more circuit units, such as a central processing unit (CPU), digital signal processor (DSP), embedded processor, etc., and any combination thereof operating independently or in parallel, including possibly operating redundantly. The processor 14 may be implemented by one or more integrated circuits (IC), including being implemented by a monolithic integrated circuit (MIC), an Application Specific Integrated Circuit (ASIC), a Field Programmable Gate Array (FGA), etc. or any combination thereof. Additionally or alternatively, the processor 14 may be implemented as a programmable logic controller (PLC), for example. The processor 14 may include circuitry for storing memory, such as digital data, and may comprise the memory circuit 16 or be in wired communication with the memory circuit 16, for example.

Typically, the memory circuit 16 and the database 18 are each all or part of a digital electronic integrated circuit. The memory circuit 16 and the database 18 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory circuit 16 and the database 18 may be operable to store memory as volatile memory, non-volatile memory, dynamic memory, etc. or any combination thereof.

The database 18 may be implemented as part of the processor 14, the memory circuit 16, or may be implemented separately from the server 12 as shown in FIG. 1. The database 18 typically functions to store information, typically in the form of recordable and retrievable data for use within or by the system 10, including data records stored in association with other data records.

The memory circuit 16 in accordance with the first embodiment of the invention contains blocks of code comprising computer executable instructions for directing the processor 14 to perform steps of methods of the system 10. Additionally or alternatively, such blocks of code may form part of a computer program product comprising computer executable instructions embodied in a signal bearing medium, which may be a recordable computer readable medium or a signal transmission type medium, for example.

By execution of its methods, the system 10 is typically operable to invoke any one or more operating systems, including real-time and non-real time operating systems such as WinCE, Symbian, OSE, Embedded LINUX, Windows, Unix, Linux, and other similar present or future operating systems or any combination thereof. The system 10 may be operable to implement multi-tasking methods involving multiple threads of executable code, for example. The system 10 is in some embodiments operable to invoke or make use of a variety of programming and communication languages, protocols, standards and environments, including C++, Java, HTML and other markup languages, flash media server and other similar present or future technologies or any combination thereof, for example.

The system 10 is preferably operable to implement one or more system 10 web pages of a system 10 website having a user interface present on the Internet 22. The system 10 is operable to permit a user to connect to and interact with the system 10 website, including browsing the system 10 web pages, receiving information from the system 10 website, submitting information to the system 10 via the system 10 website, create user account information and/or a user profile for storing in the database 18, and any combination thereof. The user profile typically includes parameters regulating the system 10 response to user input, including for example user permission levels related to otherwise unsolicited communications via e-mail from organizations associated with the system 10 website. The system 10 is operable to display on its web pages media content or other information; buttons, including Hyperlink buttons; streamed video; and any combination thereof, for example.

The user can connect to the system 10 website from any communications device operable to connect to the Internet 22, such as the user access device 24 shown in FIG. 1. Examples of communications devices suitable for use as the user access device 24 include a personal home computer, desktop computer, laptop computer, personal digital assistant, mobile telephone, iPhone (trademark), iPod (trademark), electronic game player or console, digital video disk (DVD) player, television, high definition television (HDTV), satellite television, set-top box or set-top unit, Internet protocol television (IPTV) player, kiosk, etc.

The user access device 24 connects to the Internet 22 by the Internet connection 26. The Internet connection 26 is shown in FIG. 1 as a wired connection, such as a coaxial cable, twisted pair, fiber-optic cable, or similar and any combination thereof. Additionally or alternatively, the Internet connection 26 or portions thereof may be any wireless connection, including a satellite link or line-of-sight free optical link for example. Other possibilities for the Internet connection 26 include terrestrial airborne, radio wave, digital transmission, non-line of sight and other present or future communication technologies or any combination thereof, for example.

Preferably, the user access device 24 includes or is connected to a display 28 operable to display system 10 web pages. The display 28 need not be integrally attached to the user access device 24, but can be separated and in electronic communication therewith.

When the system 10 is causing the display of a Hyperlink, such as the Hyperlink 30 shown in FIG. 1, on the display 28 of the user access device 24, the user access device 24 is typically operable to permit the user to select the Hyperlink 30, such as by clicking or double-clicking on the Hyperlink 30. The system 10 is preferably operable to respond to the user's selection of the Hyperlink 30. Selecting a Hyperlink is generally understood in the art as being intended to constitute a request by the user for user requested information associated with that Hyperlink Requests for information may include a request for media content or any particular type of information in any form suitable for displaying at a user access device 24, for example.

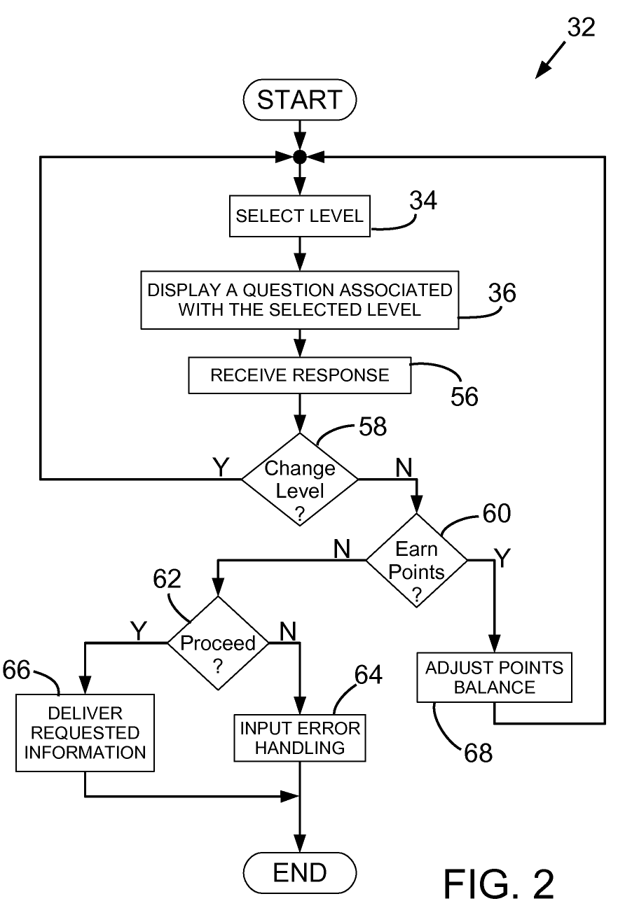

Referring to FIG. 2, the blocks of code contained in the memory circuit 16 direct the processor 14 to perform the steps of a method shown generally at 32.

In response to the user selection of the Hyperlink 30 (FIG. 1), the processor 14 is directed to begin executing the instructions of block 34. Block 34 directs the processor 14 to select a level of questions associated with the user selection of the Hyperlink 30. The question level may be indicative of the difficulty of the question, the specificity required to correctly answer the question, the topic of the question, etc. Typically, the question level associated with the user selection of the Hyperlink 30 is a first level, and other question levels can be subsequently invoked as described herein below. In general, any number of different question levels may be used by the system 10. After block 34 is executed, the processor 14 is directed to execute block 36.

Block 36 directs the processor 14 to cause the display of a question associated with the previously selected question level. Preferably, the displayed question is displayed as text in a dialog box, pop-up or similar that is presented on the display 28 at the user access device 24.

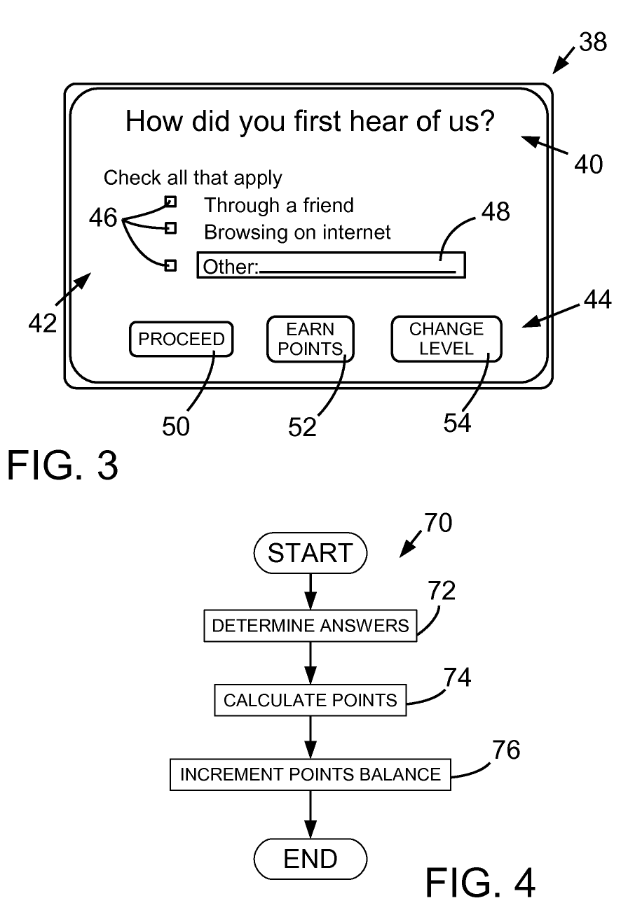

Referring to FIG. 3, an exemplary dialog box that the system 10 can use for posing a question is shown generally at 38. The dialog box 38 preferably includes a question section 40, an answer section 42 and a response section 44. The question section 40 preferably includes one question to the user, although multiple questions may posed in a single dialog box 38. The question appearing in the dialog box 38 may be a question intended to elicit information about a consumer; educate a consumer about a business, product or service; determine the level of a consumer's interest, knowledge and/or understanding of a business, product or service; provoke further interest from the user; etc., for example. The questions can be multiple-choice type questions, true-or-false type questions, open-ended or close-ended questions, for example. The answer section 42 preferably provides the user with the opportunity to respond to the question posed in the question section 40. The question section 40 preferably permits the user to provide to the system 10 one or more answers for submission by the user. The answer section 42 may include selectable answers that the user can select, such as by checking the check box 46; a text box 48 to permit the user to input free text; or other similar methods for obtaining one or more answers to the question posed in the dialog box 38, for example. The response section 44 preferably permits a user to select their desired level of participation, and potential for being awarded user points for such participation, presented by the system 10. The response section 44 preferably permits the user to select between proceeding directly to the user requested information without earning points; and earning user points by submitting one or more answers to the posed question of the question section 40. In the exemplary embodiment shown in FIG. 3, the response section 44 includes a Proceed response 50 and an Earn Points response 52, which can be presented in the form of Hyperlink buttons as shown in FIG. 3. In some embodiments and as shown in FIG. 3, the response section 44 also includes a Change Level response 54. If the user wishes to proceed directly to the user requested information, the user can select the Proceed response 50. On the other hand, if the user wishes to participate, the user can select the Earn Points response 52 or, if the user wishes to participate but at a different question level, the user can select the Change Level response 54. In some embodiments, the system 10 awards points even if the user selects the Proceed response 50 without providing any answers to a posed question. Typically, however, the potential for a user to earn points is greater if the user selects the Earn Points response 52 than if the user selects the Proceed response 50.

Referring again to FIG. 2, when the user selects one response from the response section 44 (FIG. 3), block 56 directs the processor 14 to receive the selected response. Block 58 then directs the processor 14 to determine whether the response received by executing block 56 is a request to change the question level, as when the user selects the Change Level response 54 (FIG. 3).

If the received response is a request to change the question level, the processor 14 is directed to execute block 34 to select a new level. In some embodiments, the new level may be selected by presenting to the user a menu of possible question levels and receiving from the user an indication of their selected new level. Additionally or alternatively, the system 10 can permit the user to select an extent to which the question level should be increased or decreased, for example. The system 10 is preferably operable to select the new level on the basis of the history of user interaction, including the previous question level that existed when the user requested the change in question level. The system 10 may progressively increase the difficulty of the questions being posed, for example.

In some embodiments, the system 10 is operable to select, in addition to or alternatively to selecting the question level, a points earning method. For example, the system 10 is in some embodiments operable to permit users to earn points solely for participating by providing one or more answers to the questions, whether or not the answers are factually correct, for example. Additionally or alternatively, the system 10 can permit users to earn a greater number of points when responding to questions of greater difficulty; permit users to play a sweepstakes in which points are earned for correct answers and points are lost for incorrect answers; permit users to play a “double or nothing” form of sweepstakes in which the user's accumulated points balance is doubled if the user's answer is correct, but reduced to zero if the user's answer is incorrect; permit users to compete against each other; and any combination thereof. The system 10 can in some embodiments automatically select the points earning method, select the points earning method on the basis of a user profile, select the points earning method on the basis of user input, or any combination thereof, for example.

If the received response is not a request to change the question level, the processor 14 is directed to execute block 60.

Block 60 directs the processor 14 to determine whether the response received by block 56 is a request to earn points. If the received response is not a request to earn points, the processor 14 is directed to execute block 62.

Block 62 directs the processor 14 to determine whether the response received by block 56 is a request to proceed directly to the user requested information. If the received response is not a request to proceed to the user requested information, then the processor 14 is directed to execute block 64.

Block 64 directs the processor 14 to execute input error handling in response in a manner known in the art. After executing block 64, the processor 14 is directed to end the method 32.

If block 62 determines that the received response is a request to proceed to the user requested information, then the processor 14 is directed to execute block 66. Block 66 delivers the user requested information. The system 10 preferably is operable to deliver the user requested information in the same manner as would have occurred had the method 32 not been executed after receiving the user selection of Hyperlink 30. Additionally or alternatively, the system 10 is operable to deliver the user requested information in a manner continuing to be associated with the system 10 website, such as by delivering the user requested information in conjunction with particular advertisements and other information associated with the system 10 website. Executing block 62 ends the method 32.

If block 60 determines that the received response is a request to earn points, then the processor 14 is directed to execute block 68.

Block 68 directs the processor 14 to adjust the points balance. The system 10 is preferably operable to identify the user that had selected the Hyperlink 30 and adjust the points balance associated with that user.

Referring to FIG. 4, an exemplary method for directing the processor 14 to perform steps of block 68 (FIG. 2) is shown generally at 70. Method 70 begins execution at block 72, which directs the processor 14 to determine the answers received from the user access device 24. The received answers may include selections of one or more check boxes 46 and/or contents of the text box 48, for example. Block 74 then directs the processor 14 to calculate the number of points earned by the received answers. Preferably, the number of points earned depends at least in part on the question level determined by block 34. Additionally or alternatively, the number of points earned may depend on the selected points earning method. For example, a fixed number of points, such as one point, may be earned for each correct, or otherwise acceptable, answer. By way of further example, when the points earning method invokes a “double or nothing” sweepstakes, one correct answer results in the number of points being equal to the previously accumulated points balance and any incorrect answer results in the number of points being equal to the negative of the previously accumulated points balance. Block 76 then directs the processor 14 to increment the points balance. Incrementing the points balance preferably involves adding the number of points determined by block 74 to the previously accumulated number of points to arrive at a new points balance. Where the number of points determined by block 74 is a negative amount of points, incrementing the points balance results in a loss of points. In some embodiments, a resultant negative points balance is automatically set to zero.

When block 76 has been executed, the processor 14 is directed to end the method 70 and then return to block 68 of FIG. 2.

Referring again to FIG. 2, when block 68 has been executed, the processor 14 is directed to execute block 34, with the result that the user is permitted to participate in earning further points, albeit possibly at a different question level.

In some embodiments, the system 10 is operable to proceed directly to delivering the user requested information after a predetermined number of questions have been answered in a given question-and-answer session or after a predetermined question level has been reached, for example. In such embodiments, after block 68 has been executed for the last question to be presented, the processor 14 is directed to block 66 instead of to block 34.

In some embodiments, the Change Level response 54 is not presented to the user and its associated features are not implemented. In such embodiments, block 58 of FIG. 2 is not executed and the process proceeds from block 56 to block 60. In such embodiments, however, multiple question levels, including multiple points earning methods, may be implemented according to an automatic determination. For example, the receipt of one or more correct answers may result in an increase in the difficulty of questions presented. By way of further example, the question level and/or the points earning method may be determined in least in part by the particular Hyperlink 30 selected when requesting information, by user account information, by the contents of a user profile, or any combination thereof.

In some embodiments, the system 10 is operable to award user points in response to the user requesting information, such as by selecting the Hyperlink 30, without the user submitting an answer to a question. In such embodiments, the system 10 is operable to present the user with the opportunity to earn more points by answering one or more posed questions.

### Examples of Theme-Based Operation

In some embodiments, the system 10 website is theme-based. The theme-based system 10 website can provide general information, news information, schedule information, social networking services, multimedia content, including images, videocast and broadcast productions, advertising, contests or any combination thereof that are all related and inter-related to a given theme. Themes can be any human activity or interest and can be suitable and/or intended for all ages or any particular age group or groups such as children, teenagers, adults and/or seniors, for example. The theme can be any sport, educational activity, form of entertainment, or any combination thereof, for example. By way of further example, the theme may be a motor sport such as Formula One racing. In an embodiment where the system 10 website is based on a theme of Formula One racing, the system 10 website can provide schedule and location information on upcoming races; video clips or broadcasts of past races; real-time streaming of video showing ongoing races; statistics based on past races; commentary, opinions and predictions, including expert predictions regarding upcoming races; news and editorial articles about Formula One racing; interviews, including podcasts or videocasts, of persons related to Formula One racing; chat room sessions; newsletters; electronic bulletin boards and message centers; and other related information, social networking services, multimedia content, advertising and contests related to Formula One racing. Statistics based on past races can include statistical aggregations of race results, such as race results by driver or by team, for example. Statistics of race results can be correlated with rack track conditions, weather conditions or other factors that might affect Formula One racing performance, for example.

The user can be an aficionado or enthusiast of, or otherwise have an interest in, the theme or particular human activity or interest. The user may be an adult or a child. In general, the user can be any individual, business or institution.

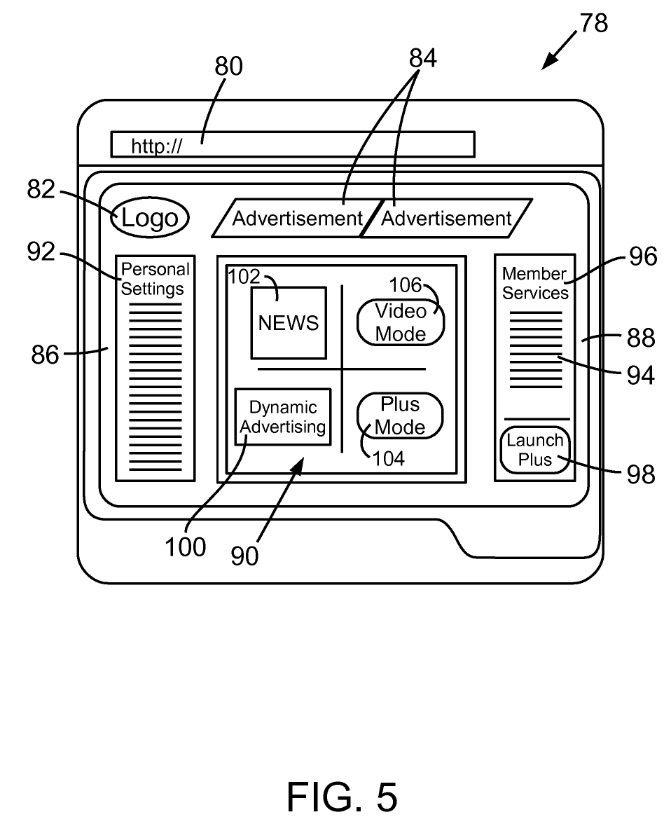

Referring to FIG. 5, the system 10 website includes a starting page, which typically is a web page of the system 10 website and may in some embodiments be the home web page of the system 10 website. Preferably, the starting page is an internal page of the system 10 website, such as the Player page 78 shown in FIG. 5. The Player page 78 is typically accessed by a user and displayed on the display 28 (FIG. 1) after linking to the URL (Uniform Resource Locator) of the Player page 78. The full URL (not shown) is typically displayed in the URL address bar or location bar 80 of the Player page 78. In some embodiments, the system 10 is operable to display the Player page 78 in response to the user selecting a desktop icon (not shown) displayed on the desktop of the user access device 24. In embodiments where the starting page is an internal page of the system 10 website, linking to the starting page, such as the Player page 78, is preferably permitted only after the system 10 has received from the user access device 24 specified user account information (e.g. user account identification and associated password) such that the user is logged in to the system 10 website.

The Player page 78 preferably includes a symbol or symbols, such as the logo 82, for identifying the system 10, including possibly identifying a theme, brand or name of the system 10, for example. One or more advertisements, such as the static advertisements 84, can be displayed on the Player page 78. The static advertisements 84 can be in the form of text, logos or other graphic artwork, Hyperlinks, or any combination thereof, for example, and can be displayed in various locations on the Player page 78, including near the top and bottom (not shown in FIG. 5) of the Player page 78.

Preferably, there is displayed a left column section 86 situated along or near the left side of the main viewing portion of the Player page 78, a right column section 88 situated along or near the right side of the main viewing portion of the Player page 78, and a central section 90 generally situated between the left column section 86 and the right column section 88. The left column section 86 can be used to display a variety of types of content or other information, including for example a list of items under a heading, such as the Personal Settings heading 92 shown in FIG. 5. Similarly, the right column section 88 can also be used to display a variety of types of content or other information, which is typically different from that displayed in the left column section 86, including for example a list 94 of items under a Member Services heading 96. The left column section 86 and the right column section 88 are not limited to each displaying only one list of items. As shown in FIG. 5, the right column section 88 displays the list 94 and a Launch Plus Hyperlink button 98, for example.

The central section 90 preferably includes a number of sub-sections displaying different forms of content or other information, possibly including dynamic information, such as the dynamic advertisements 100 shown in FIG. 5. The system 10 is operable to periodically automatically refresh the dynamic advertisements 100, continually present a cinematographic view of the dynamic advertisements 100 in the form of streaming video, or any combination thereof, for example. The system 10 is operable to display in the central section 90 information such as the news information 102 in a manner known in the art, is operable to display in the central section 90 Hyperlink buttons such as the Plus Mode Hyperlink button 104, and is operable to display in the central section 90 the Video Mode button 106.

When the user selects the Video Mode button 106 at their user access device 24, the system 10 is operable to receive the user selection and direct the processor 14 to display at the user access device 24 the Player page 78 in a video mode.

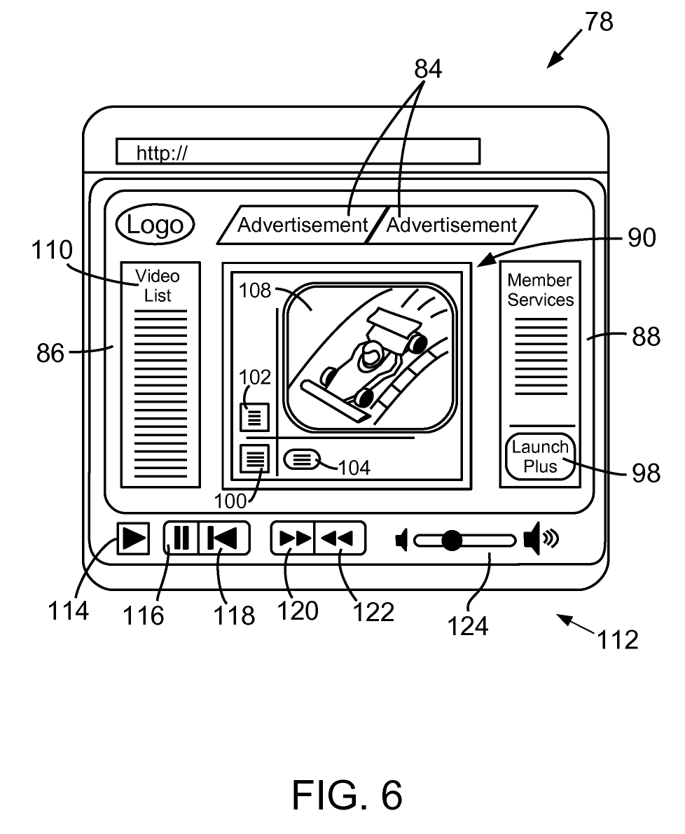

FIG. 6 shows the Player page 78 presented when the system 10 is in its video mode, in which the dynamic advertisements 100, the news information 102 and the Plus Mode Hyperlink button 104 are reduced in size and situated away from the center of the central section 90, such as by locating the dynamic advertisements 100, the news information 102 and the Plus Mode Hyperlink button 104 near a corner of the central section 90. In some embodiments, the system 10 is operable to retain the dynamic characteristics of the dynamic advertisements 100 in the video mode. Additionally or alternatively, the system 10 is operable to replace the dynamic advertisements 100 (FIG. 5) with a small icon displaying a static representation of the dynamic advertisements 100, as shown in FIG. 6. In some embodiments, the system 10 is operable to retain the hyper linking characteristics of the Plus Mode Hyperlink button 104 in the video mode. Additionally or alternatively, the system 10 is operable to replace the Plus Mode Hyperlink button 104 with a small icon displaying a non-hyperlinking button representation of the Plus Mode Hyperlink button 104, as shown in FIG. 6.

As shown in FIG. 6, the system 10 is preferably operable to replace the Video Mode button 106 (FIG. 5) with a video section 108 having a larger size than the Video Mode button 106 (FIG. 5). Additionally or alternatively, the system 10 can in some embodiments increase the size of and enhance a frame around the Video Mode button 106 (FIG. 5) to create the video section 108. In some embodiments, the system 10 increases the size of the central section 90 when creating the video section 108, and may decrease the size of other parts of the Player page 78 such as the left column section 86 and the right column section 88. Additionally or alternatively, the system 10 is operable to diminish the brightness and/or alter contrast for the display of portions of the Player page 78 other than the video section 108 when in the video mode. Additionally or alternatively, the system 10 is operable to remove from the display of the Player page 78 particular sections and/or particular content or other information when in the video mode. Preferably, the system 10 is operable to replace the content or other information displayed in the left column section 86, the right column section 88, or both the left column section 86 and the right column section 88 , with different content or other information, or remove entirely sections 86 and/or 88 when in the video mode. For example, the Personal Settings heading 92 (FIG. 5) is shown in FIG. 6 replaced by a Video List heading 110, which can be situated above a list of videos and movies available to the user for viewing. In some embodiments, the system 10 is operable to produce a split-screen view in which one portion of the screen display at the user access device 24 (FIG. 1) is used to display the video section 108. Additionally or alternatively, the system 10 can cause the video section 108 to be displayed in a full screen mode encompassing the entire display region of the display 28 (FIG. 1).

Preferably, the system 10 is operable to, within the video section 108 for display at the user access device 24, play video, including streaming video and/or playing broadcast video; play movies, including playing digital movie files; play Internet protocol television (IPTV) programs; or any combination thereof. The system 10 is operable to make available to the user a video player user interface, such as the video controls 112 shown in FIG. 6, including making the video controls 112 available when the video section 108 is created. The video controls 112 typically include any or all of a play button 114; pause button 116; restart button 118; fast forward button 120; rewind button 122; and audio volume controls, such as the audio slider 124 shown in FIG. 6. Additionally or alternatively, the system 10 can make available a slider (not shown) indicating progress in playing a video or movie file, for example. The system 10 is operable to make all, none or some of the video controls 112 available to the user at any given time. For example, the play button 114 may not be displayed when a video or movie is being played, and the pause button 116 may not be displayed when a video or movie is not being played. Other differences between the Player page 78 when in and when not in the video mode can be made. For example, the static advertisements 84 and the dynamic advertisements 100 can be relocated on the Player page 78, their advertising content can be modified or replaced, Hyperlink characteristics can be introduced to or removed from the static advertisements 84 and the dynamic advertisements 100, and any combination thereof.

In the video mode, the system 10 is operable to play video or movies related to a given theme, and typically lists under the Video List heading 110 videos and/or movies related to the theme of the system 10 website. In the case of embodiments employing the Formula One theme, the available videos and/or movies can include videos and/or movies of past Formula One races, ongoing or live Formula One races such as in the form of streaming video, interviews, related news footage, documentaries, etc.

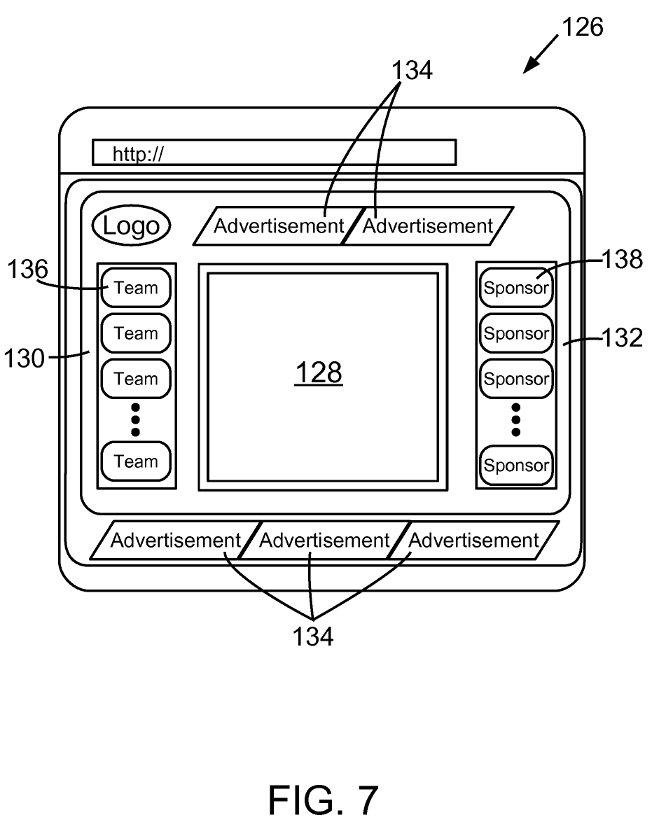

With reference to FIG. 7, when the system 10 receives an indication from a user access device 24 (FIG. 1) that the user has selected the Plus Mode Hyperlink button 104 (seen best in FIG. 5), the processor 14 is directed to cause the display of a system 10 web page associated with the Plus Mode Hyperlink button 104, such as the Plus page 126 shown in FIG. 7.

The Plus page 126 preferably includes a Plus central section 128 flanked by a Plus left section 130 situated near the left side of the Plus page 126 and a Plus right section 132 situated near the right side of the Plus page 126. In some embodiments, the Plus central section 128 includes continually refreshing content or other information such that the content or other information being displayed is periodically replaced by other content or information among a predetermined set of content or information types. Such content or information types can include content or information similar to that displayed in the central section 90 (FIGS. 5 and 6), for example.

The Plus page 126 preferably includes Plus advertisements 134, which may be static and/or dynamic, situated in various locations on the Plus page 126. For example, Plus advertisements 134 near the bottom of the Plus page 126 may include advertising for television broadcast companies involved in broadcasting Formula One races, for example. In some embodiments, the Plus advertisements include Hyperlinks to web pages associated with the entity being advertised, and such web pages may be external to the system 10 website, internal to the system 10 website, or any combination thereof. The Plus page 126 may include other content, advertising, Hyperlink buttons or other information not shown in FIG. 7.

Referring back to FIG. 5, additionally or alternatively to displaying the static advertisements 84 and the dynamic advertisements 100, the system 10 is preferably operable to include indications of branding associated with features of the system 10, such as functional features of the system 10 website. For example, the system 10 can include in or have associated with a Hyperlink displayed on a given system 10 web page one or more indications of a brand, such as a logo or other trademark. Selecting a Hyperlink directs the processor 14 to cause the display of an associated web page. If the Hyperlink is a branded Hyperlink, the system 10 is operable to cause content, advertisements or other information related to the brand to be displayed on the associated web page. In the exemplary embodiments of FIGS. 5 and 6, the system 10 can cause the display of the Plus page 126, shown in FIG. 7, when either the Launch Plus Hyperlink button 98 or the Plus Mode Hyperlink button 104 is selected. However, the Launch Plus Hyperlink button 98 in some embodiments is a branded Hyperlink displaying a brand indication such that users demonstrating interest in that brand by selecting the branded Launch Plus Hyperlink button 98 are redirected to the Plus page 126 in a branded mode. In the branded mode, the content, advertisements or other information displayed on the Plus page 126 preferably relate to the brand associated with the Launch Plus Hyperlink button 98. For example, the content or other information displayed in the Plus central section 128 might relate, or more frequently relate, to the brand associated with the Launch Plus Hyperlink button 98.

Additionally or alternatively, the system 10 is operable in some embodiments to display the Plus page 126 in response to the user selecting a desktop icon (not shown) displayed on the desktop of the user access device 24.

Still referring to FIG. 7, in embodiments where the system 10 website is associated with a Formula One racing theme, the Plus left section 130 preferably includes a list of Formula One racing teams 136 and the Plus right section 132 includes a list of stakeholders, such as the Formula One sponsors 138 shown in FIG. 7. In general, a stakeholder of the system 10 website can include a sponsor, property owner, supplier, information provider, broadcaster, or any combination thereof, for example. In embodiments where the system 10 website is theme-based, a stakeholder is typically in some way associated with the theme of the system 10 website. For example, the Formula One sponsors 138 displayed in the Plus right section 132 are organizations that are sponsoring the Formula One racing teams 136 displayed in the Plus left section 130.

The lists of Formula One racing teams 136 and Formula One sponsors 138 typically are presented in the form of Hyperlink buttons, with one Hyperlink button being provided for each Formula One racing team 136 and for each Formula One sponsor 138. However, other presentation features are possible. Preferably, when the system 10 receives from a user access device 24 an indication of the selection of a Formula One team 136 Hyperlink button, the system 10 is operable to direct the processor 14 to cause the display of a team 136 web page (not shown) associated with the selected team 136. The team 136 web page may be internal or external to the system 10 website, and may include user-generated content or other information, team-generated content or other information, or any combination thereof, for example.

When the system 10 receives from a user access device 24 the indication of a selection of a Formula One sponsor 138 Hyperlink button, the system 10 is operable to execute instructions of blocks of code stored in the memory circuit 16 such that the processor 14 is directed to perform the steps of the method 32 (FIG. 2).

Referring to FIG. 2, when the processor 14 is directed to begin performing the method 32, block 34 directs the processor 14 to select the question level as described herein above. Then block 36 directs the processor 14 to cause the display at the user access device 24 (FIG. 1) of the dialog box 38 (FIG. 3).

Referring to FIG. 3, the question appearing in the dialog box 38 preferably relates to the theme of Formula One racing, and typically relates to the particular Formula One sponsor 138 previously selected by the user as described herein above. By way of example using a fictional Formula One sponsor named “XYZ Co.”, the question being posed may ask: “Which Formula One racing teams 136 does XYZ Co. sponsor?” By such and other theme-oriented questions, the user can be educated about the relationship between the Formula One sponsors 138 and the Formula One racing teams 136. Additionally or alternatively, the user can be educated on the products and services associated with Formula One racing sponsorship, for example. After block 36 is executed, the remaining blocks of the methods 32 and 70 are executed in the manner described herein above. At block 66 of method 32, further information about the Formula One sponsor 138 is delivered to the user. Such further information may be delivered by displaying a sponsor 138 web page on the display 28 of the user access device 24. The sponsor 138 web page may be internal or external to the system 10 website, and may include user-generated content or other information, sponsor-generated content or other information, or any combination thereof, for example.

User points accumulated by participating in the Formula One racing theme-based question-and-answer features of the system 10 can be redeemed for merchandise, or reduced pricing for merchandise, offered by the Formula One sponsors 138 and/or by the Formula One racing teams 136; for media content, such as broadcast productions of past races, interviews, etc, offered by a stakeholder or the proprietor of the system 10 website; mailed information such as newsletters or magazines; invitations to special theme-related events; printed coupons for use in retail outlets of commercial establishments; and for other products or services of value, for example.

### Further Embodiments

Referring back to FIG. 1, in some embodiments the user access device 24 is a set-top box or set-top unit electrically connected to a television. The television acts as the display 28 for displaying system 10 web pages and the set-top unit is connected to the Internet 22 via a television connection system operable to permit user interactivity. The system 10 in such embodiments is operable to invoke its methods, including method 32 (FIG. 2) and method 70 (FIG. 4), such that system 10 web pages are displayed on the television set. The system 10 is also operable in such embodiments to receive user input entered by the user and transmitted to the server 12 via the television connection system. In such embodiments, the user can provide input to the system 10 in a variety of manners, including using the set-top unit itself, a remote control unit, video game console or other game console, mobile telephone or other user input device and any combination thereof. In such embodiments, the user input device and the user access device 24 are preferably in electronic communication with each other and the user access device 24 is in electronic communication with, including possibly being electrically connected to, the television set. In some embodiments, the functionality of a set-top unit is integrated into the television set such that the user access device 24 is a television set.

Additionally or alternatively, the remote control unit, game console, mobile telephone or other user input device can in some embodiments operate as the user access device 24, provided such user input device is operable to connect to the system 10 via the Internet connection 26 or similar.

In embodiments where the display 28 is a television set and the user input device or user access device 24 has its own display separate from that of the television set, such as in the case of a mobile telephone or some game consoles, the television set preferably acts as a primary display for displaying the system 10 web pages, although the display of the user access device 24 may also be used in some embodiments in conjunction with the television set. For example, the screen on a mobile telephone or game console can be used for displaying commands, navigation tools and other information related to submitting information to the system 10, while the television set can be used to display the system 10 web pages, including dialog boxes. By way of further example, a mobile telephone may act as the user access device 24, including having its own user input functions and incorporating the functionality of a set-top unit for communication with a television connection system operable to connect to the system 10. In such example, the mobile telephone is in electronic communication with the television set such that the television set and the display of the mobile telephone are available to display system 10 web pages.

In some embodiments where a user input device separate from the user access device 24 is being employed, the display 28 need not be a television set, but can be any display suitable for displaying system 10 web pages. For example in embodiments implementing a motor sport theme, the display can be a large scoreboard or screen board set up at a race track, and users can use their mobile telephones as user input devices. In such cases, users can input information to the system 10 in response to questions presented on the large screen board, for example. Additionally or alternatively, on-track personal user input devices can be provided to, including possibly being rented to, patrons at the race track. Such on-track personal user input devices can act as portable user input devices for interacting with the system 10 and may have their own screens for displaying system 10 web pages. Additionally or alternatively, such on-track personal user input devices may be used in conjunction with the large screen board acting as a display, for example.

In some embodiments, the user access devices are kiosks placed in public locations, such as cinemas, shopping malls, libraries and other government operated facilities, outdoors and other publicly accessible locations. Each such kiosk may include its own display, such as an attached monitor, and user input device, such as an attached keyboard, mouse, roll-ball, etc., as may typically be found in a personal computer or laptop, for example. In general, however, a kiosk may be used in conjunction with any suitable display and/or user input device, including mobile telephones, personal digital assistants or other portable computing devices for example.

While embodiments of the invention have been described and illustrated, such embodiments should be considered illustrative of the invention only. The invention may include variants not described or illustrated herein in detail. For example, further blocks of code may be employed to provide online redemption of accumulated points, to facilitate user control of their user profile and/or user account information, etc. Thus, the embodiments described and illustrated herein should not be considered to limit the invention as construed in accordance with the accompanying claims.

What is claimed is:

1. A software application for awarding points, the software application configurable to performing the steps comprising:
receiving a request for information from a consumer;
in response to receiving a request for information, delaying providing the requested information, and performing the steps comprising
presenting a question; and
receiving an answer to the question;
after receiving the answer, providing the requested information to the consumer; and
wherein the software application is embodied within a computer readable storage media.

2. The software application of claim 1, wherein the question relates to the information requested from the consumer.

3. The software application of claim 1 configurable to further performing the step comprising:
selecting a level; and
presenting the question associated with the selected level.

4. The software application of claim 3 configurable to further performing the steps comprising:
upon receiving the answer to the question and before providing the requested information to the consumer,
presenting a follow-up question associated with a different level; and
receiving an answer to the follow-up question.

5. The software application of claim 4, wherein the requested information is provided to the consumer after a given number of questions have been answered and/or a given level has been reached.

6. The software application of claim 3, wherein the level is indicative of a degree of difficulty of the question; a degree of specificity required for the answer; and/or a topic of the question.

7. The software application of claim 3, wherein the level is manually and/or automatically selectable.

8. The software application of claim 1 configurable to further performing the step comprising:
providing a reward to the consumer, the reward comprising money, a point, a link, a coupon, a discount, a sweepstake entrance, a product, a service, information, and/or a call to action.

9. The software application of claim 1 configurable to further performing the step comprising:
adjusting a points balance of the consumer.

10. The software application of claim 9, wherein the points balance is adjustably increased and/or a decreased.

11. The software application of claim 9, wherein the points balance is adjusted based upon viewing the question, accessing additional information based upon the question, answering the question, answering a poll-type question, forwarding the question to a friend, forwarding the question to an email account, a friend viewing the question, a friend accessing additional information based upon the question, a friend answering the question, a friend answering a poll-type question, a friend forwarding the question to another friend, viewing the requested information, forwarding the requested information to a friend, forwarding the requested information to an email account, a friend viewing the requested information, a friend forwarding the requested information to another friend, a level of difficulty of the question; an accuracy of the answer, participating in a proposed call to action, an amount pre-selected by the consumer, visiting a website, visiting a physical store, printing a coupon, using a coupon, making a purchase, and/or any other similar action.

12. The software application of claim 9 configurable to further performing the steps comprising:
upon receiving the answer to the question and before providing the requested information to the consumer,
presenting a follow-up question;
receiving an answer to the follow-up question; and
adjusting a points balance of the consumer.

13. The software application of claim 9 configurable to further performing the step comprising:
facilitating redemption by the consumer of points from the points balance for a product and/or service, a price discount for a product and/or service, free or discounted shipping, a transfer to a points balance for another consumer, and/or an exchange with points from another reward system.

14. The software application of claim 1, wherein the question is configurable to elicit information about the consumer; determine a degree of consumer interest, knowledge, and/or understanding about a product, service, and/or business; educate the consumer about a product, service, and/or business; and/or provoke interest in the consumer for a product, service, or business.

15. The software application of claim 14, wherein the product, service, or business is related to the requested information.

16. The software application of claim 1 configurable to further performing the steps comprising:
presenting an option to bypass the question; and
upon receiving a request to bypass the question, providing the requested information to the consumer.

17. The software application of claim 1 configurable to further performing the step of
providing a user interface, the user interface configurable to presenting at least one automotive racing team and at least one automotive racing team sponsor, the team configurable to being linked to content related to the team, and the sponsor configurable to being linked to content related to the sponsor;
wherein the request for information is a selection of the team and/or the sponsor by the consumer, the information is content related to the team and/or the sponsor, respectively, and the question relates to the team and/or the sponsor, respectively.

18. A system for awarding points, the system comprising:
a software application, the software application operating on a computer and configurable to communicate over a network, the software application configurable to performing the steps comprising:
receiving a redirected information request that was initiated by a consumer for information available from a third party;
in response to receiving the redirected information request, delaying providing the requested information, and performing the steps comprising
presenting a question, the question related to the information requested from the consumer; and
receiving an answer to the question;
after receiving the answer, facilitating providing the requested information to the consumer.

19. The system of claim 18, wherein the information request is through a selection of a hyperlink on a website, a bookmark, and/or a hyperlink on an email and the information is a web page related to the information request.

20. The system of claim 19, wherein the redirected information request includes an address of the web page and after receiving the answer, the software application provides the web page to the consumer using the address.

21. The system of claim 20, wherein the third party is configurable to redirect a target of a hyperlink on a website to the software application in order to elicit information about the consumer; determine a degree of consumer interest, knowledge, and/or understanding about a product, service, and/or business; educate the consumer about a product, service, and/or business; and/or provoke interest in the consumer for a product, service, or business and wherein the software application is configurable to facilitate providing the web page related to the hyperlink to the consumer without additional modification to the website.

22. The system of claim 18, wherein the third party defines the question that is displayed to the consumer.

23. The system of claim 18, wherein the software application is configurable to further performing the step comprising:
providing a wizard to assist the third party with defining the question, defining a possible answer, personalizing visual appearance of a form presenting the question, preparing software code for redirecting an information request, linking the redirected information request to the requested information, defining a reward type, defining a reward amount, and/or defining a redemption product and/or service.

24. The system of claim 18, wherein the software application is configurable to further performing the step comprising:
providing data related to the answer to the third party.

25. The system of claim 18, wherein the software application is configurable to further performing the step comprising:
selecting a level; and
presenting the question associated with the selected level.

26. The system of claim 18, wherein the software application is configurable to further performing the steps comprising:
adjusting a points balance of the consumer; and
facilitating redemption by the consumer of points from the points balance for a product and/or service and/or a price discount for a product and/or service.

27. The system of claim 18, wherein the software application is configurable to further performing the steps comprising:
presenting an option to bypass the question; and
upon receiving a request to bypass the question, facilitating providing the requested information to the consumer.

28. A software application for awarding points, the software application configurable to performing the steps comprising:
receiving an identifier from a consumer, the identifier being associated with information available to the consumer external to the software application;
in response to receiving the identifier,
presenting a question, the question related to the information available to the consumer external to the software application; and
receiving an answer to the question; and
wherein the software application is embodied within a computer readable storage media.

29. The software application of claim 28, wherein the software application is accessible to the consumer through a phone, a computer, a personal digital assistant, a standalone device, and/or a kiosk.

30. The software application of claim 28, wherein the identifier is presented visually and/or is embodied within a digital signal, an auditory signal, and/or a radio wave signal.

31. The software application of claim 28, wherein the information is educational material, an advertisement, a product, and/or a service

32. The software application of claim 28, wherein the information is embodied in a printed publication, a display, a billboard, television, time-shifted DVR, a film, a website, a logo, and/or a stadium screen.

33. The software application of claim 28, wherein the identifier and/or the information available to the consumer is presented visually, digitally, audibly, and/or through radio wave.

34. The software application of claim 28, wherein a provider of the information defines the question that is displayed to the consumer, a possible answer, a visual appearance of a form presenting the question, a reward type, a reward amount, and/or a redemption product and/or service.

35. The software application of claim 28 configurable to further performing the step comprising:
providing data related to the answer to a provider of the information.

36. The software application of claim 28 configurable to further performing the step comprising:
selecting a level; and
presenting the question associated with the selected level.

37. The software application of claim 28 configurable to further performing the steps comprising:
adjusting a points balance of the consumer; and
facilitating redemption by the consumer of points from the points balance for a product and/or service and/or a price discount for a product and/or service.

38. The software application of claim 28, wherein a provider of the information is configurable to provide the identifier to the consumer for the consumer to provide to the software application in order to elicit information about the consumer; determine a degree of consumer interest, knowledge, and/or understanding about a product, service, and/or business; educate the consumer about a product, service, and/or business; and/or provoke interest in the consumer for a product, service, or business.

39. The software application of claim 28 configurable to further performing the step comprising:
presenting a synced and/or ghost version of the information available to the consumer external to the software application.

40. A software application for awarding points, the software application comprising:
a user interface, the user interface configurable to presenting theme-based information, the theme-based information configurable to being linked to content related to the information;
wherein, in response to selection of the information by a consumer, the software application is configurable to performing the steps of
delaying providing the content related to the information;
presenting a question, the question related to the information;
receiving an answer to the question;
adjusting a points balance of the consumer;
providing the content related to the information; and
wherein the software application is further configurable to performing the step of facilitating redemption by the consumer of points from the points balance for a product and/or service and/or a price discount for a product and/or service; and
wherein the software application is embodied within a computer readable storage media.

41. The software application of claim 40, wherein the theme is automotive racing, wherein the theme-based information comprises at least one automotive racing team and at least one automotive racing team sponsor, wherein the team is configurable to being linked to content related to the team, and wherein the sponsor is configurable to being linked to content related to the sponsor.

42. The software application of claim 41, wherein the user interface is further configurable to presenting schedule and location information, archived videos, streaming videos, statistics, commentary, opinions, predictions, news, articles, podcasts, videocasts, people, chat room sessions, newsletters, messages, social networking services, interviews, documentaries, and/or advertising related to automotive racing.

43. The software application of claim 40, wherein the theme-based information is based upon any of golf, soccer, yachting, equine, horse-racing, baseball, football, hockey, basketball, cycling, Olympic games; track and field, volleyball, boxing, skiing, snowboarding, skateboarding, extreme sports, rodeo, bowling, poker, fishing, auto-repair, home-improvement, cooking, crafts, anime, cartoons, comic-books, news, daytime/prime time television, soaps, reality media, drama media, comedy media, game show media, home-shopping, film media, pay per view media, newspaper media, contests, polling, blogs, social networks, information websites, weather, mobile phone games, portable games, video games, multi-player games, advertising, marketing, polling, voting, real-estate, law, securities, stamps, coins, collectibles, commodities, currencies, boating, recreation, vehicles, aircraft, air racing, ballooning, automotive restoration, technical development, architecture, construction, travel, travelogues, vacationing, maps, directions, yellow page services, directories, music, music videos, entertainment shows, electronic press kits, contests, reality contests, re-run television, compendiums, compilations, reality shows, info-commercials, commercials, viewer sweepstakes, outcome wagering, online and offline betting, fantasy leagues, and any other theme.

44. The software application of claim 40, wherein the user interface is further configurable to presenting a brand and wherein the theme-based information, the content related to the information, and/or the question is more frequently related to the brand.
